(19) United States
(12) Patent Application Publication
(10) Pub. No.: US 2025/0054278 A1
(43) Pub. Date: Feb. 13, 2025

(54) HOME RENOVATION WITH ARTIFICIAL INTELLIGENCE

(71) Applicant: MASTERCARD INTERNATIONAL INCORPORATED, PURCHASE, NY (US)

(72) Inventors: Alonso ARAUJO, New York, NY (US); Rahmana MUHAMMAD, Brooklyn, NY (US)

(21) Appl. No.: 18/799,969

(22) Filed: Aug. 9, 2024

Related U.S. Application Data
(60) Provisional application No. 63/519,225, filed on Aug. 11, 2023.

(51) Int. Cl. G06V 10/764; G06Q 30/0601; G06T 11/00

(52) U.S. Cl. CPC G06V 10/764; G06Q 30/0623; G06Q 30/0633; G06Q 30/0641; G06T 11/00

(57) ABSTRACT

Examples assist in renovating a room, including receiving a first image of a room, being a digital image prior to a planned renovation, inputting the first image and a renovation prompt to a generative machine-learning (ML) model, being configured to generate an renovated room image from the input image and an input prompt, receiving, from the generative ML model, a second image of the room, the second image being the renovated room image, inputting the second image to a second ML model, the second ML model being configured to identify objects that appear in an input image and output a list of objects, and transmitting the second image and the list of objects to a user computing device, the list of objects being displayed as a list of items to upgrade the room to appear as shown in the second image.

### BACKGROUND

Renovating a room typically involves design planning, purchasing of all the required materials and furniture, and the skill to implement the design for the room. In most scenarios, a room is renovated in one of two ways, either the homeowner plans and executes the renovation themselves or the homeowner hires a contractor to plan and/or execute the renovation. In both scenarios, the homeowner has some plan for the room, though the contractor or an interior designer may assist. Hiring a contractor to renovate a room may be too expensive for some people and thus they may opt to perform the renovation themselves. In such a situation, the average person may have the physical ability to perform the room renovation but may not know how to do everything or where to acquire the materials. An average room renovation often involves hours of research into every step of the renovation and sourcing the appropriate tools and products.

### SUMMARY

Some examples provide a renovation planning system. The renovation planning system includes: at least one processor; and at least one memory comprising computer-readable instructions, the at least one processor, the at least one memory and the computer-readable instructions configured to cause the at least one processor to: receive a first image of a room, the first image of the room being a digital image of the room prior to a planned renovation; input the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receive, from the generative ML model, a second image of the room, the second image being the renovated room image; input the second image to a second ML model, the second ML model being configured to identify objects that appear in an input image and output a list of objects; and transmit the second image and the list of objects to a user computing device, the list of objects being displayed as a list of items to upgrade the room to appear as shown in the second image.

Some examples provide a computer-implemented method for assisting in a renovation of a room. The method comprises: receiving a first image of a room, the first image of the room being a digital image of the room prior to a planned renovation; inputting the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receiving, from the generative ML model, a second image of the room, the second image being the renovated room image; inputting the second image to a second ML model, the second ML model being configured to identify objects that appear in an input image and output a list of objects; and transmitting the second image and the list of objects to a user computing device, the list of objects being displayed as a list of items to upgrade the room to appear as shown in the second image.

Some examples provide a computer storage medium having computer-executable instructions that, upon execution by a processor of a computer, cause the processor to at least: receive a first image of a room, the first image of the room being a digital image; input the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receive, from the generative ML model, a second image of the room, the second image being the renovated room image; input the second image to a second ML model, the second ML model being configured to identify objects that appear in an input image and output a list of objects; and transmit the second image and the list of objects to a user computing device, the list of objects being displayed as a list of items to upgrade the room to appear as shown in the second image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an architecture diagram of an example renovation planning (RP) system that is configured to assist with various tasks associated with room renovation.

FIG. 2 shows an example screen of the user interface of FIG. 1 as displayed to the user by the RP device during an example room renovation.

FIG. 3 shows an example screen of the user interface of FIG. 1 as displayed to the user by the RP device when presenting an example purchase list such as the example purchase list of FIG. 1.

FIG. 4 is a flowchart of an exemplary method for assisting in a renovation of a room.

FIG. 5 is a functional block diagram of a computing apparatus according to an embodiment.

Corresponding reference characters indicate corresponding parts throughout the drawings. Any of the figures may be combined into a single example or embodiment.

### DETAILED DESCRIPTION

Room renovation involves several tasks or problems, each of which are typically addressed by humans. These tasks include, for example, creating a new design for the target room (e.g., imagining the renovated look, creating a computer-aided drafting (CAD) model of the renovated room), identifying what interior décor elements to incorporate into the design (e.g., furniture, fixtures, accessories, or the like), creating a purchase list for the renovation tasks, acquiring the items identified in the purchase list, creating a project plan (e.g., ordered task list) for performing the renovation, and implementing the project plan. Whether through human experience, artistic vision, technical ingenuity, or application of technology, these tasks are typically heavily reliant on human labor.

To assist in the renovation process, a renovation planning (RP) system is provided. The RP system uses various machine learning (ML) models to assist in many of the renovation tasks associated with room renovation. In examples, the renovation planning system uses a generative model to generate an image of a renovated room (“renovated room image”) from an image of that room prior to renovation (“original room image”) (e.g., an image of the room prior to renovation, uploaded by a user such as a homeowner, an interior decorator, or the like) in combination with a text-based description of how the room is desired to be renovated (a “renovation prompt”) (e.g., a text-based description of a décor style, theme, or specifics as to how the room is supposed to look after the renovation). This renovated image is an image of the room with additional or different room modifications or other features that enhances the room (e.g., different or additional furniture, decorations, plants, or the like).

In examples, the RP system then uses the renovated image with an object recognition model to identify a list of products that can be used to complete the renovation (e.g., particular products used to transform the room from the original image into the room in the renovated image). This list of products can be provided to a contractor or displayed to the homeowner. Further, the RP system uses the list of products to generate a purchase list for the renovation, allowing the RP system to present a list of purchasable items via an online e-commerce site. In addition, the RP system also uses an AI model to generate a list of steps (“renovation instructions”) to transform the original room into the renovated room based on the renovated image and the product list identified for the renovation. These renovation instructions can be displayed to the homeowner and/or the contractor to assist in the room renovation.

The conventional computing device operates in an unconventional manner by applying various machine learning models to improve the process of room renovation, integrating various aspects of artificial intelligence (AI) to generate a renovated room image of a room based on an original room image and a renovation theme for renovating the room, as well as identifying objects that appear in an input image and output a list of objects. In some examples, these identified objects are then searched on an e-commerce site, thereby allowing the homeowner to purchase such items for a renovation project. Further, the before and after images of the renovated room also allow the generation of a renovation plan that includes AI-generated steps or tasks that can help the homeowner complete the renovation.

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . .” For brevity and clarity of presentation, this implied leading clause is not repeated ad nauseum.

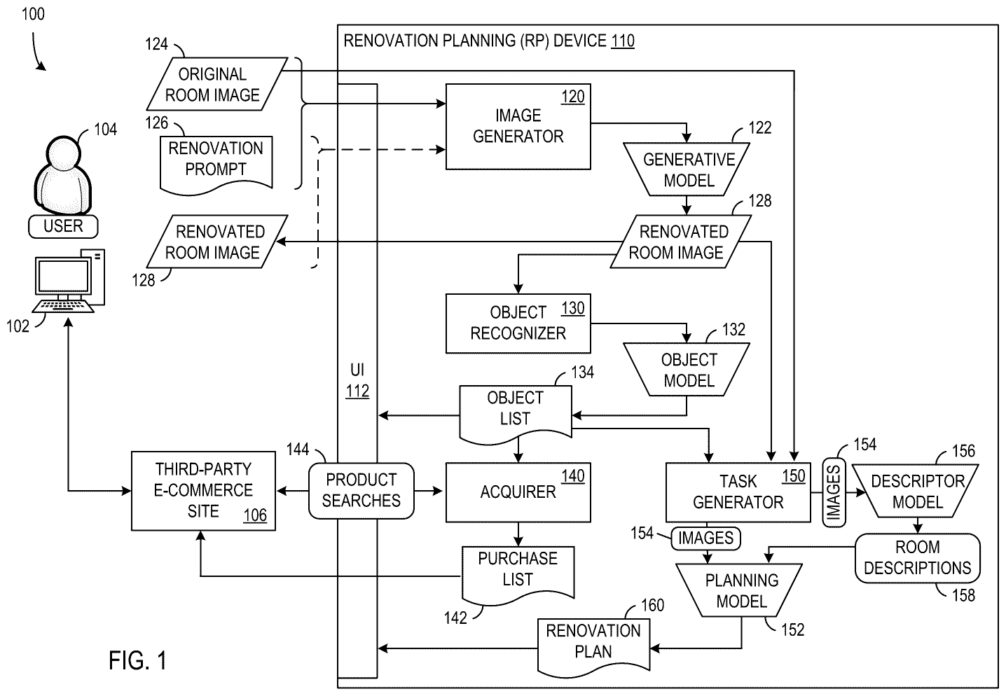

FIG. 1 is an architecture diagram of an example renovation planning (RP) system 100 that is configured to assist with various tasks associated with room renovation. In the example, the RP system 100 provides an RP device 110 through which a user 104 (e.g., a homeowner, a renovation contractor, or the like) engages with the RP system 100 via a user computing device 102 (e.g., a personal computer, smartphone, or the like). The RP device 110 allows the user 104 to plan and execute tasks associated with room renovation such as, for example, creating images of a room with various renovations, identifying and purchasing products that are used to perform those renovations, and creating renovation plans that identify tasks to be performed in order to implement the renovations.

To facilitate creating images of a renovated room, the RP device 110 provides an image generator 120 that creates image(s) of a room (the “target room,” the room that is the target of this renovation) in a renovated state (e.g., after some particular renovations are performed). More specifically, the image generator 120 utilizes a generative model 122 to create renovated room images 128 of the target room from one or more original room images 124 of the target room, as well as possibly other inputs.

In the example, the user 104 provides one or more original room images 124 of the target room taken prior to renovations. In some examples, these original room image(s) 124 are digital images of the target room in an original state, perhaps taken by the user 104 via their mobile computing device (e.g., smartphone) in an early planning stage of a renovation project. These original room image(s) 124 are provided as input to the image generator 120 (e.g., via a user interface (UI) 112 provided by the RP device 110, perhaps allowing the user 104 to upload photos of the target room). The term “original state” is used herein to refer to the state of the target room prior to any renovations (e.g., the state of the target room when the original room images 124 were captured), where the term “renovated state” is used herein to refer to the state of the target room after some renovations are applied (e.g., the state of the target room as embodied in the renovated room images 128).

Further, in some examples, the user 104 also provides a renovation prompt 126 that describes how the target room is to be renovated. In some examples, the renovation prompt 126 is a text-based description of some desired renovations (e.g., what the user 104 wishes the room to look like), or some renovation style, theme, era, country, or the like, that articulates how the room should be renovated (e.g., “modern”, “contemporary”, “traditional”, “rustic”, “industrial”, “Scandinavian”, “Bohemian”, “mid-century modern”, “minimalist”, “farmhouse”, “coastal”, “eclectic”, “Victorian”, “art deco”, “American Southwest”, “Tuscan”, or the like). For example, the user 104 describes some desired renovations as: “Renovate this room to include a four-post king-size bed, a chifforobe, powder-blue walls, a white ceiling, and white curtains.” For another example, the renovation prompt 126 includes the text: “Renovate this room with a farmhouse style,” “Apply a contemporary renovation,” or “Upgrade this room to be rustic.” Accordingly, the image generator 120 may create a prompt such as: “A room is planned to be renovated. Prior to the renovation, the room looks like {original room image}. Generate a renovated room image based on the following instructions: {renovation prompt}.” Such a prompt may then be submitted to the generative model 122, causing the generative model 122 to create the renovated room image 128.

In some examples, the RP device 110 provides a selectable list of renovation styles or themes from which the user 104 is allowed to choose, and the image generator 120 automatically generates the renovation prompt 126 based on the selection. For example, after selection of “American Southwest” and “industrial”, the image generator 120 generates renovation prompt(s) such as “Update this room image to be renovated with an {style/theme} style” (where {style/theme} is populated with a style name). In some examples, the RP device 110 automatically detects styles or themes favored by the user 104 (e.g., based on product purchase history, user preferences, historical renovations planned via the RP system 100, or the like), and may automatically generate the renovation prompt 126 based on those styles/themes. In some examples, the renovation prompt 126 allows the generative model 122 to identify the style to be used for the renovation (e.g., as a suggested style), such as: “Suggest a room renovation style and then apply that style to renovate the room in this image.”

In some examples, the RP device 110 provides a characteristics model (not shown) that is configured to identify existing characteristics of another room image (a “reference image”), and those characteristics may be used as the characteristics used in the renovation prompt 126. For example, the user 104 provides a reference image of a remodeled room that they like (e.g., perhaps other rooms of their house that they wish to match, or images of remodeled rooms that they found online). Presume that this reference image is rustic themed, and of an American Southwest design, and as such, the characteristics model may identify the characteristics “rustic” and “American Southwest” from this reference image. As such, the original room image 124 and this reference image is provided to the image generator 120, along with a renovation prompt such as: “Generate a renovated image of {original room image} in the style of {reference image}.” Accordingly, in some examples, the image generator 120 uses the characteristics model to identify characteristics from the reference image, then uses those detected characteristics to automatically generate a renovation prompt to modify the original room image based on those characteristics (e.g., “Update this room image to be renovated with a rustic and American Southwest theme”). In other examples, the image generator 120 uses the generative model 122 to directly generate the renovated room image 128 based on both the original room image 124 and the reference image (e.g., with prompt: “Update {original room image} to be renovated similar to {reference image}”).

In some examples, the RP device 110 provides a selectable list of products from which the user 104 may select for the renovation. For example, the selectable list may include categories of upgrades (e.g., seating, tables, storage, beds/bedding, dining furniture, office furniture, outdoor furniture, accent furniture, entertainment furniture, kids furniture, bedroom furniture, or the like), where each category includes various sub-categories or particular selectable items. These items may be general item descriptions (e.g., “office desk”, “mattress”, “dresser”), or they may be vendor-specific items (e.g., “IKEA MALM desk”, “Tempur-Pedic Tempur-Adapt mattress”, “West Elm Mid-Century 6-Drawer Dresser”). In some examples, the RP device 110 stores a list of preferred products and provides any or all of these products as selectable items for this renovation. As such, upon selection of one or more renovation items, the RP device 110 automatically generates the renovation prompt 126 using those selected renovation items.

The image generator 120 submits the original room image(s) 124 and the renovation prompt 126 as inputs to the generative model 122, which in turn generates the renovated image 128 as output. The generative model 122, in the example, is an AI model that is configured to edit an existing image(s) (e.g., the original room image(s) 124) based on a text prompt describing the changes to be made (e.g., the renovation prompt 126). In other words, the generative model 122 is a text-guided image editing model. In some examples, the generative model 122 is a generative adversarial network (GAN) model (e.g., “vanilla” GAN, deep convolutional GAN (DCGAN), conditional GAN (cGAN), StyleGAN, CycleGAN, or the like), a variational autoencoder (VAE) model (e.g., standard VAE, conditional VAE (CVAE), or the like), or any AI model type that enables the systems and methods described herein. In some examples, the generative model 122 is DALL-E, DALL-E 2, or CLIP (made commercially available by OpenAI), Stable Diffusion (made commercially available by Stability AI), or Imagen or Text2LIVE (made commercially available by Google Research).

In some examples, the generative model 122 is trained (e.g., by the RP device 110) to generate renovated room images (e.g., based on any of the above-described example AI model technologies). For example, the generative model 122 is trained with a corpus of room images of remodeled rooms, any or all of which may be labeled (e.g., by human, by automated process) with characteristics such as a style, theme, or the like (e.g., a plurality of “modern” room images, “contemporary” room images, “traditional” room images, “rustic” room images, and so forth). In some examples, multiple generative models 122 are trained (e.g., specific to a particular characteristic).

During an example use, presume a homeowner (e.g., as user 104) captures a digital photo of a bedroom of their primary residence and submits the photo as the original room image 124. Further, the user 104 also provides the renovation prompt 126 as: “Renovate this room with a modern style.” As such, the original room image 124 and renovation prompt 126 are submitted as inputs to the generative model 122, and the generative model 122 generates the renovated room image 128 (e.g., a modification of the original room image 124 that updates the room with “modern” style furniture, wallpaper/paint, bedding, lighting, flooring, and the like). As such, the renovated room image 128 is displayed to the homeowner via the UI 112. This presentation allows the user 104 to view the renovated room image 128 and consider whether they would like to proceed with this renovation suggestion.

In some examples, the RP device 110 allows the user 104 to refine or change the renovated room image 128 by submitting that renovated room image 128 and a new renovation prompt 126 to the image generator 120 to get a new renovated room image 128 (e.g., perhaps affecting some addition, removal, or other alteration to the existing renovated room image 128). For example, presume that the homeowner likes most of the renovations implemented during generation of the first renovated room image 128 but wishes to have vertical blinds added to a glass door in the room. As such, the next renovation prompt 126 is submitted as: “Update the renovated room to have vertical blinds added to the glass door.” As such, this prompt 126 and first renovated room image 128 are submitted as inputs to the generative model 122, which generates a second renovated room image 128 having all the renovations of the first image 128 and now with vertical blinds added to the glass door. As such, the RP device 110 allows the user 104 to continue editing the renovated room image 128 until they are happy with the state of the renovated room image 128.

Once the renovated room image 128 has been finalized, the user 104 proceeds with other renovation planning tasks to affect this renovation. In the example, the RP device 110 also provides an object recognizer 130 that is configured to identify the renovations that appear in the renovated room image 128 (e.g., in a “single-image analysis”), or renovations that occur between the original room image 124 and the renovated room image 128 (e.g., in a “before-and-after-image analysis”). In some examples, the object recognizer 130 uses an object model 132 to identify objects (e.g., furniture, decorations, wallpaper, flooring, appliances, cabinetry, accessories, and the like) and other characteristics of the remodeled room (e.g., from the renovated room image 128). These objects are provided as an object list 134 (e.g., a list of objects that appear in the renovated room image 128). In other examples, the object model 132 uses both the original room image 124 and the renovated room image 128 to identify the changes that occur between the two images, and these changes are provided as an object list 134 (e.g., the objects that appear in the renovated room image 128 that did not appear in the original room image 124). In some examples, the object model 132 also takes prompt text (not shown) such as, for example, “What objects appear in {renovated room image}”, or “What objects are needed to change {original room image} into {renovated room image}”.

In some examples, the object model 132 is a convolutional neural network (CNN) that is configured to identify specific characteristics of the target room, such as furniture, color schemes, architectural features, or the like. In some examples, the object model 132 is an object detection model such as, for example, You Only Look Once (YOLO), single shot multibox detector (SSD), or Faster R-CNN to detect and classify objects within a room, such as chairs, tables, beds, and so forth. In some examples, the object model 132 is a semantic segmentation model such as, for example, U-Net, SegNet, or DeepLab that is configured to perform pixel-wise classification of an image to help in understanding the layout and identifying various elements and regions within a room. In some examples, the object model 132 is a scene recognition model such as, for example, Places365, which is configured to classify the type of room (e.g., kitchen, bedroom, living room) and provide context about the overall scene. In some examples, the object model 132 is an image captioning model that is configured to generate textual descriptions of an image, combining CNNs for image feature extraction as well as recurrent neural networks (RNNs) or transformers for generating text (e.g., models like the Show, Attend and Tell or transformer models such as CLIP or ViT-GPT that can describe various aspects of a room. In some examples, the object model 132 is a feature extraction model with deep learning that is configured to extract high-level features from images, which associates images with textual descriptions to help identify characteristics by mapping image features to textual labels.

In the example, the RP device 110 provides an acquirer 140 that is configured to assist the user 104 in acquiring the objects identified in the object list 134. For example, presume the object list 134 includes a list of furniture appearing in the renovated image 128 (e.g., a queen-sized bed, a headboard), a particular flooring appearing in the renovated image 128 (e.g., a particular carpet or hardwood flooring), one or more bedding items (e.g., comforter, sheets, pillows), lighting (e.g., wall lights, ceiling fan), and wall coverings (e.g., a particular color of paint or a particular wallpaper). In some examples, the object list 134 includes one or more characteristics of each object identified in the list 134, such as an object type or object name (e.g., bed frame, comforter, ceiling fan, vertical blinds), a particular vendor make/models for the object, particular characteristics of the object (e.g., queen-sized bed frame and comforter, 4-blade ceiling fan, oak flooring).

As such, the acquirer 140 uses such characteristics of each object to identify purchase options for each of these objects in the object list 134. In the example, the RP device 110 interfaces with a third-party e-commerce site 106 that offers such room renovation products for sale. In some examples, the acquirer 140 executes product search(es) 144 for each of the items appearing in the object list 134 (e.g., using the object characteristics as search terms within the e-commerce site 106). The UI 112 displays each item from the object list 134 to the user 104 along with any of the products identified for that item from the product search 144 for that item. For example, for the queen-sized bed item on the object list 134 (e.g., “queen-sized bed”), the associated product search 144 identified several queen-sized bed frames, queen-sized box springs, queen-sized mattresses, and queen-sized bedding. As such, the UI 112 allows the user 104 to view any and all of these options for this particular item, allowing the user 104 to select which particular item(s) they wish to purchase for this item. These items are added to a purchase list 142 for this renovation. In some examples, the product search 144 may have identified only one particular item, and the acquirer 140 may automatically select that item to be included in the purchase list 142. In some examples, the acquirer 140 searches an internal product list to identify one or more products for particular items identified in the object list 134 (e.g., from a pre-defined product list offered by preferred providers). Further, when the user 104 has finalized the purchase list 142, the acquirer 140 submits the purchase list 142 to the third-party e-commerce site 106, which in turn allows the user 104 to complete an e-commerce transaction to purchase the listed products.

In the example, the RP device 110 also facilitates planning the steps needed to complete the renovation via a task generator 150. The task generator 150 uses one or more of the object list 134, the renovated room image 128, and optionally the original room image 124, to generate a renovation plan 160 for this renovation. The renovation plan 160 represents a set of instructions (e.g., a task list) that describes how to implement the renovations depicted in the renovated room image 128.

More specifically, in examples, the task generator 150 uses a planning model 152 to generate the renovation plan 160. The planning model 152 is a model that is configured to take, as inputs (shown collectively as “images 154” in FIG. 1), one or more of the object list 134, the renovated room image 128, and possibly the original room image 124, as well as a text-based “renovation planning prompt” (not separately shown) that instructs the planning model 152 in the construction of the renovation plan 160. For example, the renovation planning prompt is: “Generate a renovation plan to convert {original room image} into {renovated room image}. A list of renovation items is included in {object list}. The renovation plan should include an ordered list of tasks to be performed to complete the room renovation. Each item in {object list} should appear in at least one task, where the task describes how that item is to be used in that task. Be as concise as possible.” The planning model 152 can be any AI model sufficient to enable the systems and methods described herein.

In some examples, the task generator 150 divides the renovation plan 160 into several components based on pre-defined task types. For example, a set of common task types is pre-defined in the task generator 150, such as “flooring”, “walls/ceiling”, “electrical”, “furniture”, “appliances”, “windows”, “accessories/decorations”, or the like. Each task type includes one or more sub-types. For example, the “electrical” task type includes “lighting”, “fan”, “switches”, “in-wall”, “electronic devices”, or such sub-groups related to electrical renovations, “furniture” task type may include “beds”, “lounging”, “desks”, “tables”, “dressers”, or such sub-groups related to furniture renovations, and the like). In some examples, groups of task types are pre-defined for particular room types. For example, bedrooms include “electrical-lighting”, “electrical-fan”, “furniture-beds”, “furniture-dressers”, and the like, where kitchens may include “sink”, “countertop”, “cabinetry”, “appliances-ovens”, “appliances-refrigerators”, and the like.

The task generator 150 may identify a room type for the target room (e.g., based on room description 158 of the image(s) 124, 128) and may thus identify a set of task types commonly used to renovate that type of room. In such examples, the task generator 150 generates the renovation plan 160 one task type at a time. For example, the planning model 152 is used to generate a renovation plan for the “electrical-lighting” tasks (e.g., what tasks are needed to renovate the lighting components). For example, one planning prompt includes: “Generate a renovation plan to renovate the lighting in {original room image} into {renovated room image}. A list of lighting items is included in {electrical lighting object list}. Identify the tasks needed to complete the electrical renovation using the lighting items. Be as concise as possible.” Similarly, the planning model 152 may also be used to generate a renovation plan for the “furniture-beds” tasks (e.g., what tasks are needed to renovate the bedding furniture). For example, another planning prompt includes: “Generate a renovation plan to renovate the bedding in {original room image} into {renovated room image}. A list of bedding items is included in {bedding object list}. Identify the tasks needed to complete the bedding renovation using the bedding items. Be as concise as possible.” Similarly, the task generator 150 may use the planning model 152 to separately generate renovation plans for each task type, and may thus combine each of these separate renovation plans into the renovation plan 160 for the target room.

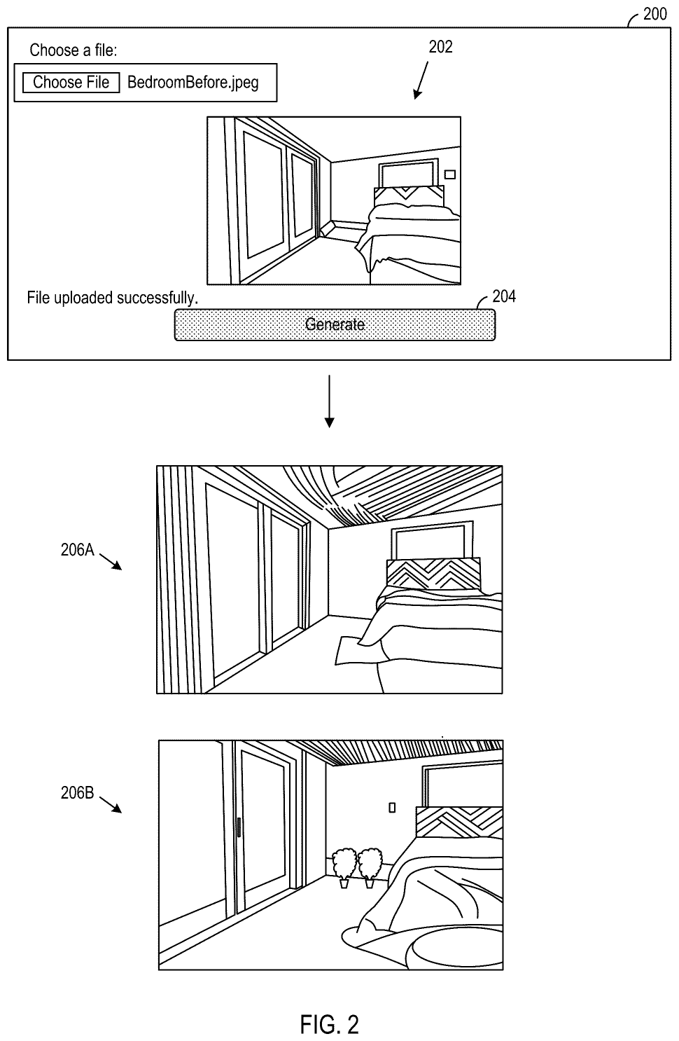

In some examples, the task generator 150 additionally uses a descriptor model 156 to generate room descriptions 158 from one or more of the original room image 124 and the renovated room image 128. More specifically, the descriptor model 156 is configured to generate a room description 158 from a given input image, where the room description 158 is a text-based output that describes various features of the input image (e.g., features of the room shown in the image 124, 128). For example, a room description 158 for an example renovated room image 128 (e.g., image 206A, shown in FIG. 2) is “A bedroom having a queen-sized bed, lighting fixtures on a wall adjoining the bed, and multiple floor-to-ceiling windows on a wall adjacent to the bed. The bed includes a comforter, pillows, satin sheets, a headboard, and an end-of-bed bench at the foot of the bed. The windows include vertical blinds.”

As such, in some examples, the room description(s) 158 is used as additional or alternate input(s) to the planning model 152 when generating the renovation plan 160. For example, the planning model 152 is configured to use the original room image 124 and renovated room image 128 in conjunction with the room description(s) 158 of either or both images 124, 128 when generating the renovation prompt. Consider the following prompt that integrates the room description of the renovated room image 128 into the prompt: “Generate a renovation plan to convert {original room image} into {renovated room image}. A list of renovation items to appear in the renovated room are included in {object list}. Prior to the renovation, the room includes {room description of the original room image}. After the renovation, the room includes {room description of the renovated room image}. The renovation plan should include an ordered list of tasks to be performed to complete the room renovation. Each item in {object list} should appear in at least one task, where the task describes how that item is to be used in that task. Be as concise as possible.” For another example, the planning model 152 is configured to use just the room descriptions 158 of the two images 124, 128 (e.g., in lieu of images 124, 128, and possibly object list 134). Consider the following prompt: “Generate a renovation plan to renovate a room. Prior to the renovation, the room includes {room description of the original room image}. After the renovation, the room includes {room description of the renovated room image}. The renovation plan should include an ordered list of tasks to be performed to complete the room renovation. Be as concise as possible.”

In some examples, the descriptor model 156 is an image captioning model such as, for example, Show, Attend and Tell (a model that uses a combination of CNNs for image feature extraction and RNNs for generating descriptive text, which also incorporates attention mechanisms to focus on different parts of the image while generating the description), a neural image caption generator (e.g., using CNNs for encoding the image and RNNs (e.g., LSTMs) for decoding the features into a sentence), or transformer models such as Vision Transformer (ViT) and language models (e.g., using the ViT to extract features from the image and then feed these features into the transformer-based language model such as GPT-3 to generate descriptions), CLIP (e.g., extracting meaningful features from the image and then inputting these features into the language model to generate a description), RNNs or transformers (e.g., to generate a descriptive text based on the detected objects and their spatial relationship via feeding the detected object labels and positions into a language model). As such, the room descriptions 158 can include features extracted from the images 154, and/or full room descriptions of the image.

As such, the renovation plan 160 generated by the planning model 152 includes a list of tasks (e.g., ordered, unordered, categorized by task type), where each task describes renovation steps to be performed to affect a portion of the renovation. Accordingly, the performance of each of the tasks identified in the renovation plan 160 should lead to the target room being transformed from the original room image into the renovated room image.

The renovation plan 160 is displayed to the user 104 via the UI 112, allowing the user 104 to view the tasks identified in the renovation plan 160. In some examples, the user 104 wishes to get further details regarding the overall renovation plan 160, or for some specific task(s) included in the plan 160. In such situations, the RP device 110 allows the user 104 to request additional details from the planning model.

For example, consider a task in an example renovation plan 160 for the flooring component of the renovation, where the original task included: “Flooring-Replace the existing carpet with hardwood flooring included in the purchase list.” However, the user 104 may want more details regarding how the old carpet is removed, or how the hardwood flooring replacement is performed. As such, the user 104 enters a renovation plan request such as: “Provide more details regarding how the existing carpet can be removed” or “Add more details regarding how the hardwood flooring installation is performed.” Accordingly, the task generator 150 provides the initial renovation plan 160 and some or all of the object list 134, the images 124, 128, and/or the room descriptions 158 as inputs to the planning model 152, and generates a new prompt for updating the renovation plan 160 based on the request of the user 104. For example, consider the following renovation plan update prompt: “A room renovation is planned to convert {original room image} into {renovated room image}. The current renovation plan includes tasks defined by {current renovation plan}. Update some or all of the tasks in the renovation plan based on the following: {renovation plan request}. Display a new renovation plan.” Accordingly, the planning model 152 outputs an updated renovation plan 160 based on the prior plan and modifications made based on the renovation plan request entered by the user 104. As such, the user 104 continues improving the renovation plan 160 until they are content with the level of detail to perform the renovation.

While some examples shown herein are described as utilizing only a single original room image 124 of the target room, or generating only a single renovated room image 128 of a renovated room, it should be understood that these systems and methods can be modified to use several original room images 124 of the target room (e.g., from different perspectives, thereby showing additional room content, or other walls, furniture, or other items not seen from certain perspectives), and/or to generate multiple renovated room images 128 (e.g., from different perspectives). For example, renovation prompts 126 input to the generative model 122 are modified to include clauses such as: “A room is planned to be renovated. Prior to the renovation, the room looks like {first original room image} from a first perspective, and {second original room image} from a second perspective. Generate a renovated room image based on the following instructions: {renovation prompt}.” Likewise, the renovation prompts 126 may be modified to generate multiple renovated room images 128 with clauses such as: “A room is planned to be renovated. Prior to the renovation, the room looks like {first original room image} from a first perspective, and {second original room image} from a second perspective. Generate a first renovated room image and a second renovated room image of the room based on the following instructions: {renovation prompt}. Make the first renovated room image from the same perspective as seen in first original room image}, and make the second renovated room image from the same perspective as see in {second original room image}.”

As such, the RP device 110 uses generative AI and other machine learning models to generate renovated room images 128 from original room images 124, identify objects that appear in the renovated room, facilitate purchase of the items needed to perform a renovation, and generate a renovation plan 160 that describes how to perform the renovation. While the models 122, 132, 152, 156 are shown in FIG. 1 as provided by the RP device 110, it should be understood that any of these models 122, 132, 152, 156 may, additionally or alternatively, be provided external to the RP device 110 (e.g., as third-party models, perhaps provided via the Internet via an application programming interface (API) or the like).

FIG. 2 shows an example screen 200 of the user interface 112 of FIG. 1 as displayed to the user 104 by the RP device 110 during an example room renovation. In the example, the user 104 has captured a digital image of the target room (e.g., a bedroom), shown here as original room image 202. The target room initially includes a double bed with a headboard and a quilt, a framed window above the headboard of the bed, a windowed double door with semi-transparent blinds, and an area rug covering most of the floor, as well as several other items and features. This original room image 202 is uploaded, via the screen 200, as the original room image 124. Further, in this example, the user 104 inputs a renovation prompt 126 (not shown in FIG. 2) such as: “Suggest a few different styles for renovating this room and show me a few options.”

In response to user input via generate button 204, the RP device 110 generates two renovated room images 206A, 206B (as examples of renovated room images 128). The first renovated room image 206A includes a queen-sized bed with a first headboard, satin sheets, a comforter, and an end-of-bed bench, a window cover for a window above the bed, floor-to-ceiling windows (e.g., in place of the original doors) with vertical blinds, carpet flooring (e.g., in place of the original rug), a few wall-mounted lights on a wall adjacent to the bed, as well as several other items and features. Likewise, the second renovated room image 206B also includes a queen-sized bed with a second headboard, a window above the bed (e.g., similar to the original room), a different wood-framed and windowed double door, and different carpet flooring, as well as several other items and features. Each of these images 206A, 206B are generated using different themes selected by the image generator 120 or the generative model 122 (e.g., based on the renovation prompt 126).

In some examples, the UI 112 also includes a description (not shown in FIG. 2) of the pre-renovated room image 202 and/or a description of the renovated room image 206A, 206B (e.g., from room descriptions 158). For example, the description of renovated image 202 is displayed as “a bed sitting in a bedroom next to a sliding glass door, inspired by Gregory Crewdson, under construction, light boho carped, Colorado, French door window, 2022 photo, commercial photo, 500 s, 2045, DIY, poor quality, high elevation, front.” The description of the renovated room image 206A may be displayed as “a bed sitting in a bedroom next to a window, a digital rendering, by Jaako Mattila, shutter beautiful house on a forest path, wooden ceiling, shipping containers, wide angle shot 4 k, the hillside, Finland, big French door window, bamboo, hippie pad, with vegetation, stunning design, listing image.”

In some examples, the UI 112 includes step-by-step renovation instructions (not shown) for carrying out the renovation of the room to look same or similar to the representation shown in the image of the post-renovated room 206A and/or 206B. For example, such step-by step renovation instructions (e.g., as an example of renovation plans 160 of FIG. 1) include:
A. Replace the sliding glass door with a big French door window in the first room (pre-renovation) to match the second room (post renovation).
B. Remove any rubble and debris from the room.
C. Install a wooden ceiling and bamboo features in the first room to match the design elements of the second room.
D. Add more vegetation to the surroundings of the first room to match the forest path setting of the second room.
E. Remove the light boho carpet from the first room and replace it with a more muted color palette, inspired by the Aladár Körösföi-Kriesch style of the second room.
F. Consider incorporating some of the liminal space elements from the second room, such as the neighborhood theme or color blocking.
G. Install a plant or more furniture in the first room to match the second room's cozy and well-decorated feel.
H. Add additional lighting to the room, potentially with new overhead or floor lamps.

As seen in the step-by step renovation instructions above, while the image of the room to be renovated is uploaded, in some examples, the RP device 110 also provides instructions to renovate the space outside the room (e.g., to add more vegetation to the surroundings of the first room to be renovated to match the forest path setting of the second room, i.e., post-renovation room generated by the AI model).

In some examples, a single renovation theme is applied when the user 104 selects the option to generate the image of the renovated room. In some examples, a plurality of renovation themes is applied even when the user 104 selects the option to generate the image of the renovated room once. How many and which renovation themes to apply may be determined based on user preferences, promotors of the renovation themes (e.g., some of the registered companies providing renovation themes may actively opt to advertise their products and/or renovation themes), the renovation themes having positive feedback from a predetermined number of other users for similar rooms, and so forth.

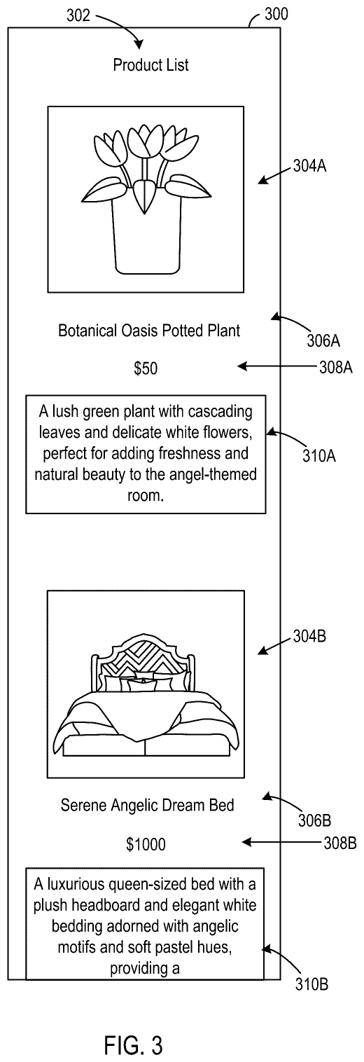

FIG. 3 shows an example screen 300 of the user interface 112 of FIG. 1 as displayed to the user 104 by the RP device 110 when presenting an example purchase list 302 such as the example purchase list 142 of FIG. 1. In the example, the RP device 110 performs product searches 144 using an object list 134 generated from the example renovated room image 206B shown in FIG. 2. This example renovated room image 206B includes a queen-sized bed and a couple of potted plants adjacent to the bed. As such, the example object list 134 includes potted plants and queen-sized bed as items present in the renovated room image 206B. As such, the product searches 144 identified a “Botanical Oasis Potted Plant” (as shown by item description 306A), as well as a “Serene Angelic Dream Bed” (as shown by item description 306B). For each of these respective items, the RP device 110 displays an item image 304A, 304B, an item description 310A, 310B, and an item price 308A, 308B (e.g., as made commercially available via third-party e-commerce site 306, shown in FIG. 1).

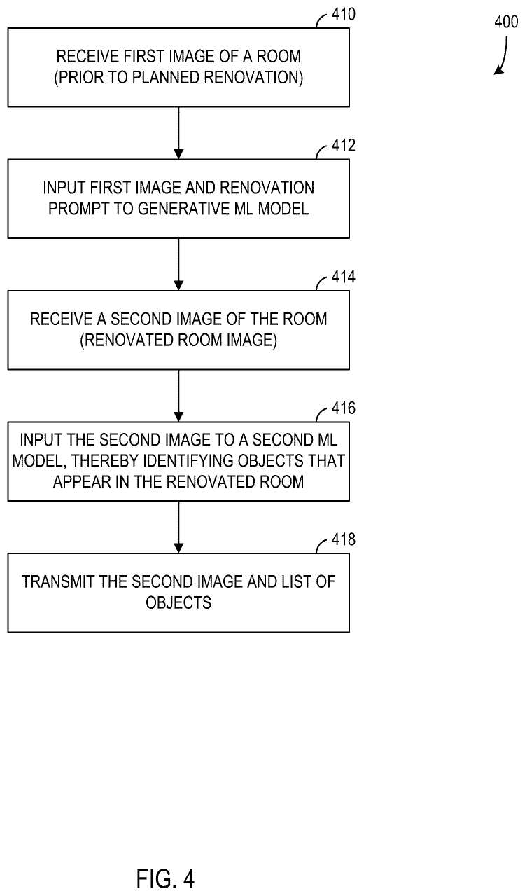

FIG. 4 is a flowchart of an exemplary method 400 for assisting in a renovation of a room. In some examples, the method 400 is performed by the RP device 110 shown in FIG. 1. In the example, at operation 410, the RP device 110 receives a first image of a room (e.g., original room image 124), the first image of the room being a digital image of the room prior to a planned renovation. At operation 412, the RP device 110 inputs the first image and a renovation prompt (e.g., renovation prompt 126) to a generative machine-learning (ML) model (e.g., generative model 122), the generative ML model being configured to generate an output image from an input image and a text-based input prompt (e.g., renovation prompt 126) that provides instruction for modifying the input image, the renovation prompt instructing the generative ML model to generate a renovated room image of the room based on the first image and a renovation theme for renovating the room.

At operation 414, in the example, the RP device 110 receives, from the generative ML model, a second image of the room (e.g., renovated room image 128), the second image being the renovated room image. At operation 416, the RP device 110 inputs the second image to a second ML model, the second ML model being configured to identify objects that appear in an input image and output a list of objects. At operation 418, the RP device 110 transmits the second image and the list of objects to a user computing device, the list of objects being displayed as a list of items to upgrade the room to appear as shown in the second image.

In some examples, the RP system 110 also transmits a product search message to an e-commerce system, the product search message identifying one or more search terms associated with a first item from the list of objects, receives product information for one or more products offered for sale by the e-commerce system based on the product search message, and displays the product information as a purchase option for the first item. 10. In some examples, the RP system 110 also receives user input identifying a first product selection from the one or more products, the first product selection identifying at least one product of the one or more products, generates a purchase list that includes the at least one product, and transmits the purchase list to the e-commerce system, thereby causing the e-commerce system to add the at least one product to a purchase cart.

In some examples, the RP system 110 inputs the first image, the second image, the list of objects, and a renovation planning prompt to a planning ML model, the renovation planning prompt being configured to cause the planning ML model to generate a task list identifying one or more renovation tasks to renovate the room to appear as shown in the second image using items included in the list of objects, receives, from the planning ML model, a renovation plan, the renovation plan including a plurality of renovation tasks, and transmits the renovation plan to the user computing device, the plurality of renovation tasks being displayed to a user. In some examples, the RP system 110 also inputs one of the first and second images to a descriptor ML model, the descriptor ML model being configured to generate, as output, a text-based description of an input image, receives a room description of the one of the first and second images as output of the descriptor ML model, and adding at least one component of the room description in the renovation planning prompt, thereby causing the planning ML model to add the at least one component of the room description as context when generating the renovation plan. In some examples, the RP system 110 also receives first user input identifying a task appearing in the renovation plan and second user input describing a request associated with the task, generates a renovation plan update prompt that instructs the planning ML model to alter the task in the renovation plan based on the second user input, and inputs at least the renovation plan and the renovation plan update prompt to the planning ML model, thereby causing the planning ML model to output an updated renovation plan.

In some examples, the RP system 110 receives first user input describing a request to change the first image, generates a second renovation prompt that includes at least the second image and the first user input along with instructions to the generative ML model to alter the second image as specified in the first user input, and receives, from the generative ML model, a third image of the room, the third image being an updated version of the second image, and transmits the third image to the user computing device.

### Exemplary Operating Environment

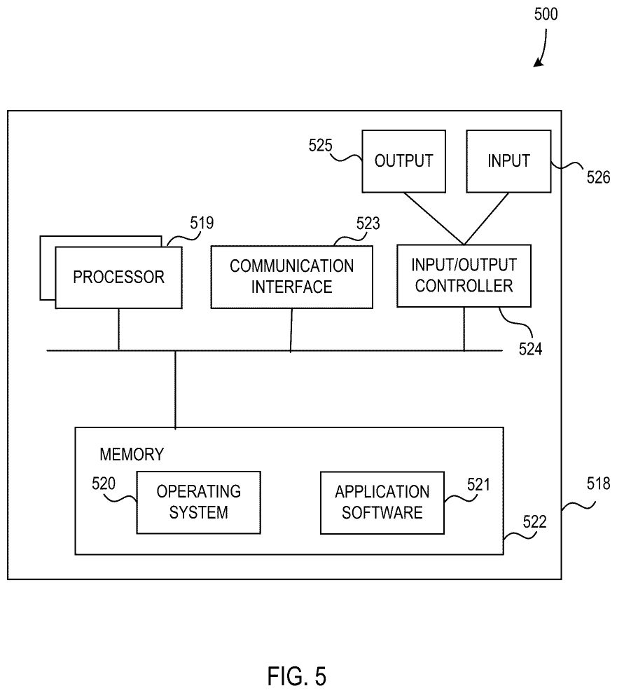

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 is a computing device, such as, but not limited to, the user computing device 102 or the RP device 110 in FIG. 1.

The computing apparatus 518 comprises one or more processors 519 which can be microprocessors, controllers, or any other suitable type of processors for processing computer executable instructions to control the operation of the electronic device. Alternatively, or in addition, the processor 519 is any technology capable of executing logic or instructions, such as a hardcoded machine. In some examples, platform software comprising an operating system 520 or any other suitable platform software is provided on the apparatus 518 to enable application software 521 to be executed on the device. In some examples, receiving and routing RPC messages from external sources to microservice rails of a microservice platform as described herein is accomplished by software, hardware, and/or firmware.

In some examples, computer executable instructions are provided using any computer-readable medium or media accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 in other examples outputs data to devices other than the output device, e.g., a locally connected printing device. In some examples, a user provides input to the input device(s) 526 and/or receives output from the output device(s) 525.

The functionality described herein can be performed, at least in part, by one or more hardware logic components. The computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Additional Examples

In some examples, a renovation planning system is provided. The renovation planning system includes at least one processor; and at least one memory comprising computer-readable instructions, the at least one processor, the at least one memory and the computer-readable instructions configured to cause the at least one processor to: receive a first image of a room, the first image of the room being a digital image of the room prior to a planned renovation; input the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receive, from the generative ML model, a second image of the room, the second image being the renovated room image; input the second image to a second ML model, the second ML model being configured to identify objects that appear in an input image and output a list of objects; and transmit the second image and the list of objects to a user computing device, the list of objects being displayed as a list of items to upgrade the room to appear as shown in the second image.

In some examples, a computer-implemented method for assisting in a renovation of a room is provided. The method includes receiving a first image of a room, the first image of the room being a digital image of the room prior to a planned renovation; inputting the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receiving, from the generative ML model, a second image of the room, the second image being the renovated room image; inputting the second image to a second ML model, the second ML model being configured to identify objects that appear in an input image and output a list of objects; and transmitting the second image and the list of objects to a user computing device, the list of objects being displayed as a list of items to upgrade the room to appear as shown in the second image.

In some examples, a computer storage medium is provided. The computer storage medium has computer-executable instructions that, upon execution by a processor of a computer, cause the processor to at least: receive a first image of a room, the first image of the room being a digital image; input the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receive, from the generative ML model, a second image of the room, the second image being the renovated room image; input the second image to a second ML model, the second ML model being configured to identify objects that appear in an input image and output a list of objects; and transmit the second image and the list of objects to a user computing device, the list of objects being displayed as a list of items to upgrade the room to appear as shown in the second image.

Alternatively, or in addition to the other examples described herein, examples include any combination of the following:
receiving a first image of a room;
the first image of the room being a digital image of the room prior to a planned renovation;
inputting the first image and a renovation prompt to a generative ML model;
the generative ML model being configured to generate an output image from an input image and a text-based input prompt that provides instruction for modifying the input image;
the renovation prompt instructing the generative ML model to generate a renovated room image of the room based on the first image and a renovation theme for renovating the room;
receiving, from the generative ML model, a second image of the room, the second image being the renovated room image;
inputting the second image to a second ML model;
the second ML model being configured to identify objects that appear in an input image and output a list of objects;
transmitting the second image and the list of objects to a user computing device;
the list of objects being displayed as a list of items to upgrade the room to appear as shown in the second image;
transmitting a product search message to an e-commerce system;
the product search message identifying one or more search terms associated with a first item from the list of objects;
receiving product information for one or more products offered for sale by the e-commerce system based on the product search message;
displaying the product information as a purchase option for the first item;
receiving user input identifying a first product selection from the one or more products;
the first product selection identifying at least one product of the one or more products;
generating a purchase list that includes the at least one product;
transmitting the purchase list to the e-commerce system;
causing the e-commerce system to add the at least one product to a purchase cart;
inputting one or more of the first image, the second image, the list of objects, and a renovation planning prompt to a planning ML model;
the renovation planning prompt being configured to cause the planning ML model to generate a task list identifying one or more renovation tasks to renovate the room to appear as shown in the second image using items included in the list of objects;
receiving, from the planning ML model, a renovation plan, the renovation plan including a plurality of renovation tasks;
transmitting the renovation plan to the user computing device, the plurality of renovation tasks being displayed to a user;
inputting one of the first and second images to a descriptor ML model;
the descriptor ML model being configured to generate, as output, a text-based description of an input image;
receiving a room description of the one of the first and second images as output of the descriptor ML model;
adding at least one component of the room description to the renovation planning prompt;
causing the planning ML model to add the at least one component of the room description as context when generating the renovation plan;
receiving first user input identifying a task appearing in the renovation plan and second user input describing a request associated with the task;
generating a renovation plan update prompt that instructs the planning ML model to alter the task in the renovation plan based on the second user input;
inputting at least the renovation plan and the renovation plan update prompt to the planning ML model;
causing the planning ML model to output an updated renovation plan;
receiving first user input describing a request to change the first image;
generating a second renovation prompt that includes at least the second image and the first user input along with instructions to the generative ML model to alter the second image as specified in the first user input;
receiving, from the generative ML model, a third image of the room;
the third image being an updated version of the second image; and
transmitting the third image to the user computing device.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for assisting in a renovation of a room; receiving a first image of a room, the first image of the room being a digital image of the room prior to a planned renovation; inputting the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receiving, from the generative ML model, a second image of the room, the second image being the renovated room image; inputting the second image to a second ML model, the second ML model being configured to identify objects that appear in an input image and output a list of objects; and transmitting the second image and the list of objects to a user computing device, the list of objects being displayed as a list of items to upgrade the room to appear as shown in the second image.

At least a portion of the functionality of the various elements in FIG. 1 to FIG. 5 can be performed by other elements in FIG. 1 to FIG. 5, or an entity (e.g., processor, web service, server, application program, computing device, etc.) not shown in FIG. 1 to FIG. 5.

In some examples, the operations illustrated in FIG. 1 and FIG. 4 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium has instructions recorded thereon which when executed by a computer device cause the computer device to cooperate in performing a method for assisting in a renovation of a room, the method comprising: receiving a first image of a room, the first image of the room being a digital image of the room prior to a planned renovation; inputting the first image and a renovation prompt to a generative machine-learning (ML) model, the generative ML model being configured to generate an output image from an input image and a text-based input prompt that provides instruction for modifying the input image, the renovation prompt instructing the generative ML model to generate a renovated room image of the room based on the first image and a renovation theme for renovating the room; receiving, from the generative ML model, a second image of the room, the second image being the renovated room image; inputting the second image to a second ML model, the second ML model being configured to identify objects that appear in an input image and output a list of objects; and transmitting the second image and the list of objects to a user computing device, the list of objects being displayed as a list of items to upgrade the room to appear as shown in the second image.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A renovation planning system comprising:
at least one processor; and
at least one memory comprising computer-readable instructions, the at least one processor, the at least one memory and the computer-readable instructions configured to cause the at least one processor to:
receive a first image of a room, the first image of the room being a digital image of the room prior to a planned renovation;
input the first image and a renovation prompt to a generative machine-learning (ML) model, the generative ML model being configured to generate an output image from an input image and from a text-based input prompt that provides instruction for modifying the input image, the renovation prompt instructing the generative ML model to generate a renovated room image of the room based on the first image and a renovation theme for renovating the room;
receive, from the generative ML model, a second image of the room, the second image being the renovated room image;
input the second image to a second ML model, the second ML model being configured to identify objects that appear in an input image and output a list of objects; and
transmit the second image and the list of objects to a user computing device, the list of objects being displayed as a list of items to upgrade the room to appear as shown in the second image.

2. The renovation planning system of claim 1, wherein the computer-readable instructions are further configured to cause the at least one processor to:
transmit a product search message to an e-commerce system, the product search message including one or more search terms associated with a first item from the list of objects;
receive product information for one or more products offered for sale by the e-commerce system based on the product search message; and
display the product information as a purchase option for the first item.

3. The renovation planning system of claim 2, wherein the computer-readable instructions are further configured to cause the at least one processor to:
receive user input identifying a first product selection from the one or more products, the first product selection identifying at least one product of the one or more products;
generate a purchase list that includes the at least one product; and
transmit the purchase list to the e-commerce system, thereby causing the e-commerce system to add the at least one product to a purchase cart.

4. The renovation planning system of claim 1, wherein the computer-readable instructions are further configured to cause the at least one processor to:
input the first image, the second image, the list of objects, and a renovation planning prompt to a planning machine-learning (ML) model, the renovation planning prompt being configured to cause the planning ML model to generate a task list identifying one or more renovation tasks to renovate the room to appear as shown in the second image using items included in the list of objects;
receive, from the planning ML model, a renovation plan, the renovation plan including a plurality of renovation tasks; and
transmit the renovation plan to the user computing device, the plurality of renovation tasks being displayed to a user.

5. The renovation planning system of claim 4, wherein the computer-readable instructions are further configured to cause the at least one processor to:
input one of the first and second images to a descriptor ML model, the descriptor ML model being configured to generate, as output, a description of an input image;
receive a room description of the one of the first and second images as output of the descriptor ML model; and
add at least one component of the room description in the renovation planning prompt, thereby causing the planning ML model to add the at least one component of the room description as context when generating the renovation plan.

6. The renovation planning system of claim 4, wherein the computer-readable instructions are further configured to cause the at least one processor to:
receive first user input identifying a task appearing in the renovation plan and second user input describing a request associated with the task;
generate a renovation plan update prompt that instructs the planning ML model to alter the task in the renovation plan based on the second user input; and
input at least the renovation plan and the renovation plan update prompt to the planning ML model, thereby causing the planning ML model to output an updated renovation plan.

7. The renovation planning system of claim 1, wherein the computer-readable instructions are further configured to cause the at least one processor to:
receive first user input describing a request to change the first image;
generate a second renovation prompt that includes at least the second image and the first user input along with instructions to the generative ML model to alter the second image as specified in the first user input; and
receive, from the generative ML model, a third image of the room, the third image being an updated version of the second image; and
transmit the third image to the user computing device.

8. A computer-implemented method for assisting in a renovation of a room, the method comprising:
receiving a first image of a room, the first image of the room being a digital image of the room prior to a planned renovation;
inputting the first image and a renovation prompt to a generative machine-learning (ML) model, the generative ML model being configured to generate an output image from an input image and an input prompt that provides instruction for modifying the input image, the renovation prompt instructing the generative ML model to generate a renovated room image of the room based on the first image and a renovation theme for renovating the room;
receiving, from the generative ML model, a second image of the room, the second image being the renovated room image;
inputting the second image to a second ML model, the second ML model being configured to identify objects that appear in an input image and output a list of objects; and
transmitting the second image and the list of objects to a user computing device, the list of objects being displayed as a list of items to upgrade the room to appear as shown in the second image.

9. The computer-implemented method of claim 8, further comprising:
transmitting a product search message to an e-commerce system, the product search message identifying one or more search terms associated with a first item from the list of objects;
receiving product information for one or more products offered for sale by the e-commerce system based on the product search message; and
displaying the product information as a purchase option for the first item.

10. The computer-implemented method of claim 9, further comprising:
receiving user input identifying a first product selection from the one or more products, the first product selection identifying at least one product of the one or more products;
generating a purchase list that includes the at least one product; and
transmitting the purchase list to the e-commerce system, thereby causing the e-commerce system to add the at least one product to a purchase cart.

11. The computer-implemented method of claim 8, further comprising:
inputting the first image, the second image, the list of objects, and a renovation planning prompt to a planning machine-learning (ML) model, the renovation planning prompt being configured to cause the planning ML model to generate a task list identifying one or more renovation tasks to renovate the room to appear as shown in the second image using items included in the list of objects;
receiving, from the planning ML model, a renovation plan, the renovation plan including a plurality of renovation tasks; and
transmitting the renovation plan to the user computing device, the plurality of renovation tasks being displayed to a user.

12. The computer-implemented method of claim 11, further comprising:
inputting one of the first and second images to a descriptor ML model, the descriptor ML model being configured to generate, as output, a description of an input image;
receiving a room description of the one of the first and second images as output of the descriptor ML model; and
adding at least one component of the room description to the renovation planning prompt, thereby causing the planning ML model to add the at least one component of the room description as context when generating the renovation plan.

13. The computer-implemented method of claim 11, further comprising:
receiving first user input identifying a task appearing in the renovation plan and second user input describing a request associated with the task;
generating a renovation plan update prompt that instructs the planning ML model to alter the task in the renovation plan based on the second user input; and
inputting at least the renovation plan and the renovation plan update prompt to the planning ML model, thereby causing the planning ML model to output an updated renovation plan.

14. The computer-implemented method of claim 8, further comprising:
receiving first user input describing a request to change the first image;
generating a second renovation prompt that includes at least the second image and the first user input along with instructions to the generative ML model to alter the second image as specified in the first user input;
receiving, from the generative ML model, a third image of the room, the third image being an updated version of the second image; and
transmitting the third image to the user computing device.

15. A computer storage medium having computer-executable instructions that, upon execution by a processor of a computer, cause the processor to at least:
receive a first image of a room, the first image of the room being a digital image;
input the first image and a renovation prompt to a generative machine-learning (ML) model, the generative ML model being configured to generate an output image from an input image and an input prompt that provides instruction for modifying the input image, the renovation prompt instructing the generative ML model to generate a renovated room image of the room based on the first image and a renovation theme for renovating the room;
receive, from the generative ML model, a second image of the room, the second image being the renovated room image;
input the second image to a second ML model, the second ML model being configured to identify objects that appear in an input image and output a list of objects; and
transmit the second image and the list of objects to a user computing device, the list of objects being displayed as a list of items to upgrade the room to appear as shown in the second image.

16. The computer storage medium of claim 15, wherein the computer-executable instructions are further configured to cause the processor to:
transmit a product search message to an e-commerce system, the product search message including one or more search terms associated with a first item from the list of objects;
receive product information for one or more products offered for sale by the e-commerce system based on the product search message; and
display the product information as a purchase option for the first item.

17. The computer storage medium of claim 16, wherein the computer-executable instructions are further configured to cause the processor to:
receive user input identifying a first product selection from the one or more products, the first product selection identifying at least one product of the one or more products;
generate a purchase list that includes the at least one product; and
transmit the purchase list to the e-commerce system, thereby causing the e-commerce system to add the at least one product to a purchase cart.

18. The computer storage medium of claim 15, wherein the computer-executable instructions are further configured to cause the processor to:
input the first image, the second image, the list of objects, and a renovation planning prompt to a planning machine-learning (ML) model, the renovation planning prompt being configured to cause the planning ML model to generate a task list identifying one or more renovation tasks to renovate the room to appear as shown in the second image using items included in the list of objects;
receive, from the planning ML model, a renovation plan, the renovation plan including a plurality of renovation tasks; and
transmit the renovation plan to the user computing device, the plurality of renovation tasks being displayed to a user.

19. The computer storage medium of claim 18, wherein the computer-executable instructions are further configured to cause the processor to:
input one of the first and second images to a descriptor ML model, the descriptor ML model being configured to generate, as output, a description of an input image;
receive a room description of the one of the first and second images as output of the descriptor ML model; and
add at least one component of the room description in the renovation planning prompt, thereby causing the planning ML model to add the at least one component of the room description as context when generating the renovation plan.

20. The computer storage medium of claim 15, wherein the computer-executable instructions are further configured to cause the processor to:
receive first user input describing a request to change the first image;
generate a second renovation prompt that includes at least the second image and the first user input along with instructions to the generative ML model to alter the second image as specified in the first user input; and
receive, from the generative ML model, a third image of the room, the third image being an updated version of the second image; and
transmit the third image to the user computing device.
